(19) United States
(12) Patent Application Publication
(10) Pub. No.: US 2006/0068079 A1
(43) Pub. Date: Mar. 30, 2006

(54) Method for the manufacture of dried water-absorbed rice

(76) Inventor: Yukio Ishida, Shizuoka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/075,662

(22) Filed: Mar. 10, 2005

(30) Foreign Application Priority Data
Sep. 28, 2004 (JP) 2004-282610

(51) Int. Cl. A23L 1/18

(52) U.S. Cl. 426/618

(57) ABSTRACT

In accordance with the present invention, a material rice is heated at high temperature for a short period so that gelatinized and pasty layer is formed at the surface of rice grains and the resulting material rice having the formed pasty layer is heated in an aqueous liquid at 75 to 98° C. (temperature of the material) for 30 seconds to 20 minutes and then subjected to air-drying and/or drying under reduced pressure whereupon it is now possible to manufacture dried water-absorbed rice having water content of less than 43% to 10%; the dried water-absorbed rice according to the present invention has a rearranged starch grain group of starch grains due to heat variation in its central area and, when cooked by heating, it is able to strongly generate nice smell of freshly cooked rice.

### TECHNICAL FIELD

The present invention relates to a method for the manufacture of dried water-absorbed rice in which there is a starch particle group rearranged by heat variation at the central area of water-absorbed rice and water content is dried to less than 43% to 10%. When water is added to the resulting dried water-absorbed rice and cooked by heating, nice smell of freshly cooked rice is able to be strongly resulted.

All the percentages of water contents mean w/w % in the present specification.

### BACKGROUND ART

Up to now, manufacture of water-absorbed rice has been carried out in such a manner that a material rice is not completely cooked but heating is stopped on the way and, after that, water is absorbed with rice grains.

A representative example of water-absorbed rice is mentioned as follows in Patent Document 1.

Thus, “Highly water-absorbed rice in which, in the first step, rice is treated with hot water, steam and/or pressurized steam to prepare water-absorbed rice in which water content is made 38 to 115 parts by weight of water to 100 parts by weight of rice, the resulting water-absorbed rice is subjected to any of treatments of refrigerating, freezing, freezing after refrigerating and refrigerating after freezing and, in the second step, the product is steeped in water, hot water, stock liquid, soup, sauce or the like for a predetermined period, water is further absorbed therewith and total amount of absorbed water is made 72 to 130 parts by weight to 100 parts by weight of rice”.

Patent Document 1: Japanese Patent No. 2,821,562

The water-absorbed rice as such is not completely made into an α-form and, in terms of a degree of α-conversion (where a method for measuring degree of gelatinization (degree of α-conversion) is in accordance with a glucoamylase method mentioned in Non-Patent Document 1), it is about 50% to 75% and its object is generation of nice smell of freshly cooked rice when the product is cooked by heating before eating.

Non-Patent Document 1: “Denpun Kagaku Handbook” (Handbook of Starch Chemistry), 11th Edition, published on Jul. 15, 1991 by Asakura Shoten, pages 242 to 243

However, when the conventional water-absorbed rice of a degree of α-conversion of 50% to 75% is cooked by heating using, for example, a 500-watt microwave oven for 2 to 5 minutes, although it is possible to achieve nice smell of freshly cooked rice to some extent, the resulting nice smell is not so good as that of the freshly cooked rice which is well cooked using a kettle.

### DISCLOSURE OF THE INVENTION

Problems that the Invention is to Solve

An object of the present invention is to provide dried water-absorbed rice which is able to achieve a nice smell upon cooking which is as good as that of freshly cooked rice which is well cooked using a kettle even when water-absorbed rice of a degree of α-conversion is about 85% to 35%.

### BRIEF DESCRIPTION OF DRAWINGS

FIG. 1 is a picture of cross section near a central area of water-absorbed rice (water content: 65%) under a scanning electron microscope.

FIG. 2 is a partially enlarged picture of the picture of FIG. 1.

FIG. 3 is a picture of surface of the water-absorbed rice of the present invention under a scanning electron microscope.

FIG. 4 is a picture of surface of uncooked rice (polished rice) under a scanning electron microscope.

FIG. 5 is a picture of cross section near a central area of uncooked rice (polished rice) under a scanning electron microscope.

FIG. 6 is a partially enlarged picture of the picture of FIG. 5.

FIG. 7 is a picture of surface of commercially available cooked rice (water content: 65%) distributed at ambient temperature under a scanning electron microscope.

FIG. 8 is a picture of cross section near a central area of the commercially available cooked rice (water content: 65%) distributed at ambient temperature under a scanning electron microscope.

FIG. 9 is a partially enlarged picture of the picture of FIG. 8.

### MEANS FOR SOLVING THE PROBLEMS

In the present invention, a material rice is heated at high temperature for a short period so that gelatinized and pasty layer is formed at the surface of rice grains, the resulting material rice having pasty layer is heated in an aqueous liquid at 75 to 98° C. (temperature of the material) for 30 seconds to 20 minutes and dried with air and/or dried under reduced pressure and the resulting dried water-absorbed rice is cooked by heating after addition of water thereto whereupon nice smell of freshly cooked rice is strongly noted and, as compared with the nice smell of rice cooked by heating of the water-absorbed rice of Patent Document 1, better nice smell of freshly cooked rice is achieved.

When the part near the central area of the water-absorbed rice (water content: 65%) before drying of the dried water-absorbed rice prepared by the present invention was cut and picture of the inner side under a scanning electron microscope was taken, a group of rearranged starch particles due to heat variation which has not been noted yet was found. In the dried water-absorbed rice prepared by the present invention, water content of the water-absorbed content was lowered and there is no particular change in its inner structure.

The dried water-absorbed rice manufactured by the present invention has the following physicochemical properties:

1. Starch grains specific to uncooked rice are not contained;

2. A layer which is gelatinized and pasty is present at its surface;

3. In the inner part of the pasty layer except the central area, there are starch grains which are swollen by containing starch in a melted state;

4. The central area has a rearranged group of starch grains due to heat variation;

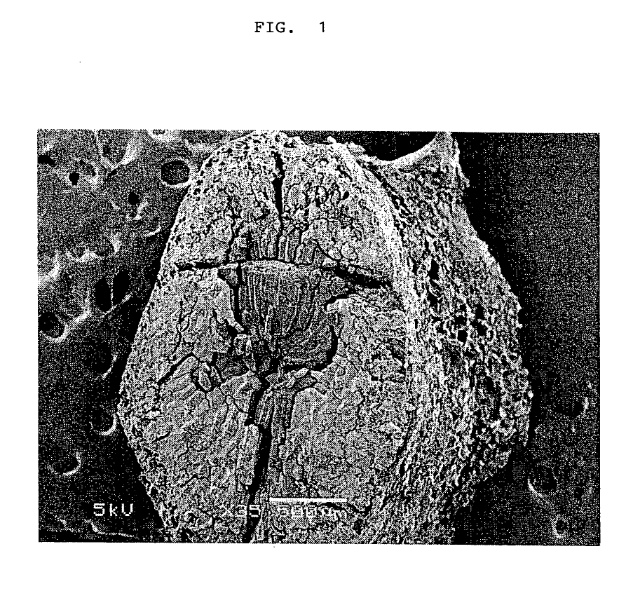

5. A three-layered structure comprising the layer which is gelatinized and pasty, the starch grains which are swollen by containing starch in a melted state and the rearranged group of starch grains due to heat variation is as shown in the picture under a scanning electron microscope of FIG. 1; and

6. When it is cooked by heating, nice smell of freshly cooked rice is strongly noted.

Now, the water-absorbed rice before drying according to the present invention, uncooked rice and commercially available cooked rice will be illustrated by way of FIG. 1 to FIG. 9, all of which are pictures as substitutes for drawings. All of FIG. 1 to FIG. 9 are pictures under a scanning electron microscope.

The water-absorbed rice (water content: 65%) before air-drying according to the present invention is cut near a central area and FIG. 1 shows its cross section. In the right side of a rice grain, a layer which is a bit thick, white and pasty is noted while, in the left side, a layer which is narrow, white and pasty is noted.

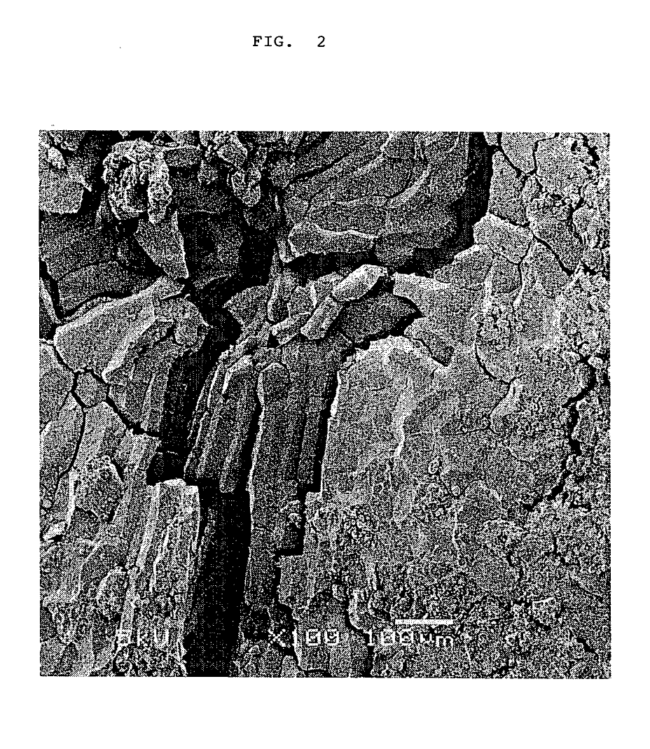

In the central area, there is a part which is in an inverted triangular shape and is somewhat black. That is a rearranged starch grain group of starch grains due to heat variation which has not been confirmed yet and is noted to be hardly made into paste (an α-form). It is able to be well confirmed in FIG. 2.

In addition, except the rearranged starch grain group of starch grains in the inverted triangular shape in the central area, the area between the pasty layers is filled with swollen starch grains containing starch in a melted state.

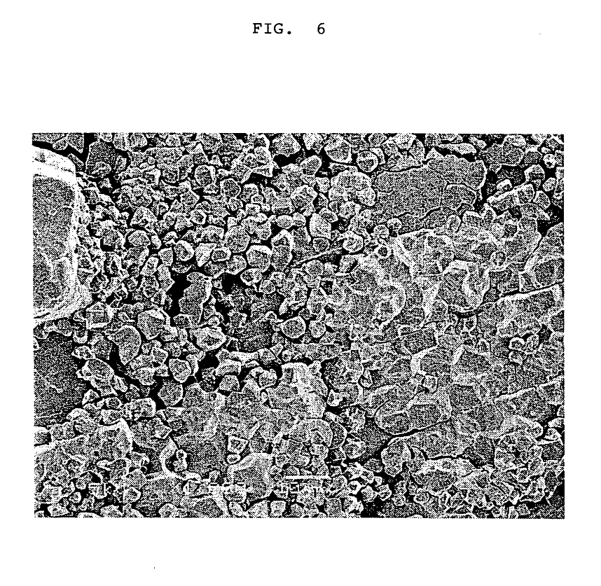

As shown in the picture of FIG. 6 as a substitute for drawing, starch grains of uncooked rice have some gaps and seem to be hard and they are starch grains which are not gelatinized.

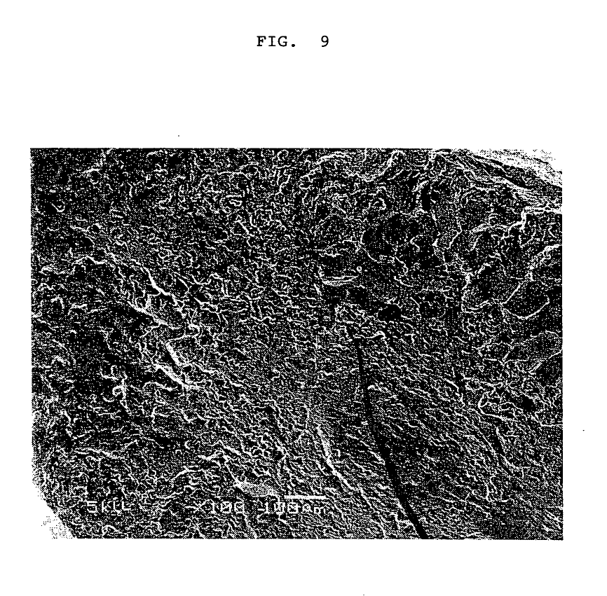

On the contrary, in the swollen starch grains in FIG. 1, the starch grains of uncooked rice of FIG. 6 are swollen as they are and the starch grains remain as they are. Swelling of starch grains and the starch grains are clearly noted at the right side of FIG. 2. On the other hand, as shown in FIG. 9, in a cross section near the central part of commercially available cooked rice, the inner part is completely gelatinized and starch membrane is disordered showing a contrast to that in FIG. 1 or 2.

FIG. 2 is a partially enlarged picture of FIG. 1. In FIG. 2, a lower part of the inverted triangle in FIG. 1 is noted where a rearranged starch grain group due to heat variation is clearly observed. Except in the rearranged starch grain group of starch grains which is in somewhat black color, swollen starch grains containing starch in a melted state are clearly observed.

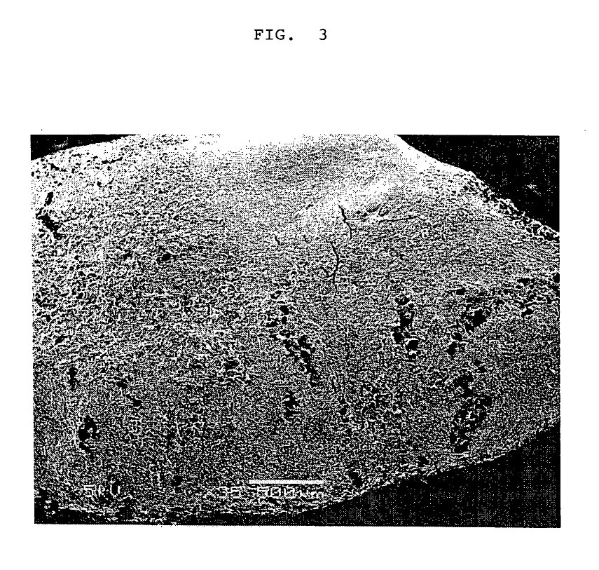

FIG. 3 is a picture taking the surface of a rice grain of the water-absorbed rice of the present invention. It is noted that the surface is covered by a pasty layer.

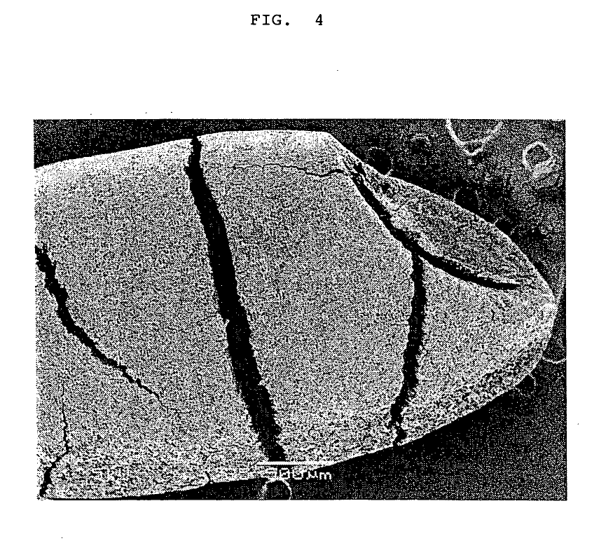

FIG. 4 is a picture taking the surface of uncooked rice which is washed by bubbles. It is noted that cracks are present in some places.

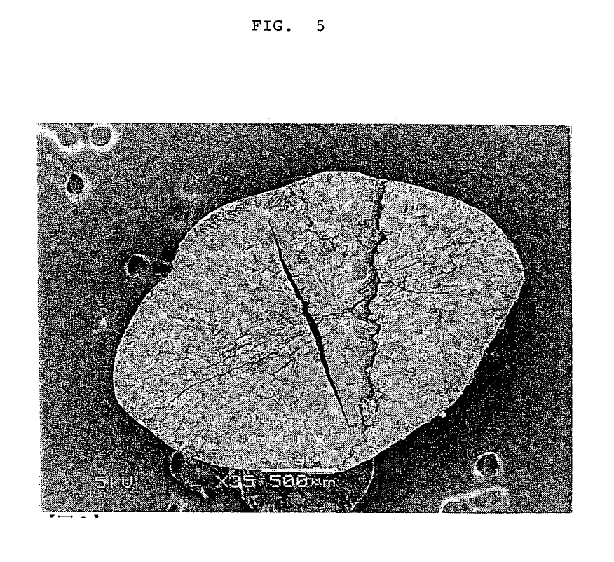

FIG. 5 is a picture of cross section near the central area of uncooked rice. It is noted that entire rice grain is filled with starch grains almost uniformly.

FIG. 6 is a partially enlarged picture of FIG. 5. It is noted that starch grains in the inner area of uncooked rice are filled accompanied by some gaps.

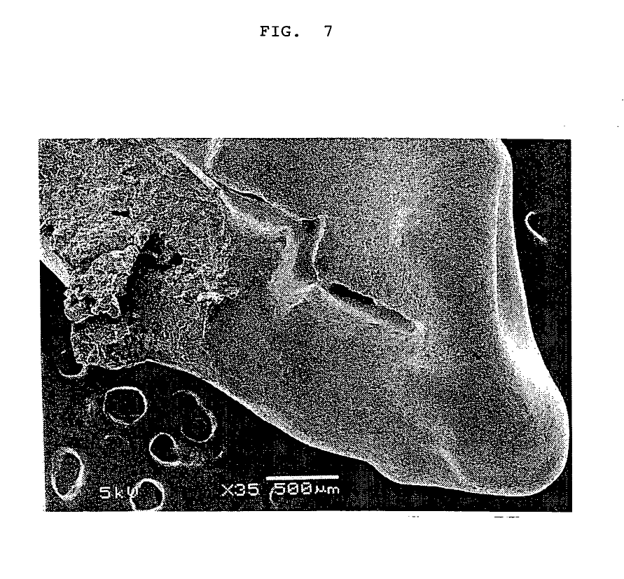

FIG. 7 is a picture where surface of commercially available cooked rice (water content: 65%) distributed at ambient temperature is taken. It is wholly gelatinized, a pasty surface is noted and partial deficiency is noted in the left side.

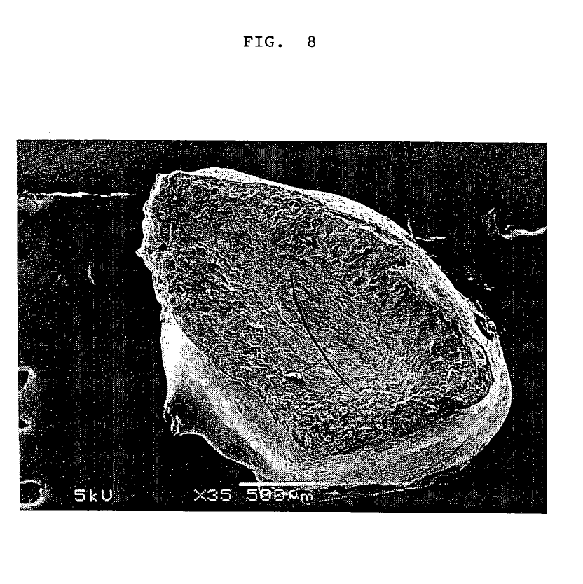

FIG. 8 is a picture of nearly the central area of the rice grain of FIG. 7. It is noted that, in the surrounding, there is a pasty layer while, in the inner side, whole area is gelatinized, starch grains are crumbled and starch membrane is in disorder.

FIG. 9 is a partially enlarged picture of FIG. 8. It is noted that the inner side of the rice grain is uniformly gelatinized and starch membrane is in disorder.

The method for the manufacture of the dried water-absorbed rice according to the present invention comprises the following three steps.

1. A material rice is heated at high temperature for a short period by using a heating means so that gelatinized and pasty layer is formed at the surface of rice grains. The material rice includes nonglutinous rice and glutinous rice, and may be polished rice or unpolished rice. The state of the material rice to be subjected to use includes non-washed rice, washed rice and steeped rice (i.e., rice which is steeped in water, etc. and then taken out therefrom). The heating means includes unpressurized steam, heated steam, pressurized steam and pressurized high-temperature water.

2. The resulting material rice having the formed pasty layer is heated in an aqueous liquid at 75 to 98° C. (temperature of the material) for 30 seconds to 20 minutes. As a result of heating as such, a degree of α-conversion of rice grains becomes not more than 85%, preferably 80% to 35% or, more preferably, 75% to 50%. The aqueous liquid includes water, stock, soup, etc., which may be heated aqueous liquid. The heated aqueous liquid is warm, hot or boiling one. The heated aqueous liquid includes warm water, hot water, boiling water, warm stock, hot stock, boiling stock, etc.

A degree of α-conversion of the heated rice grains is not more than 85%, preferably 80% to 35% or, more preferably, 75% to 50%.

3. The material rice having the formed pasty layer is heated to such an extent that a degree of α-conversion of rice grains becomes not more than 85%, preferably 80% to 35% or, more preferably, 75% to 50% and subjected to air-drying and/or drying under reduced pressure to give the dried water-absorbed rice of the present invention having the following physicochemical properties.

Physicochemical Properties:

1. Starch grains specific to uncooked rice are not contained;

2. A layer which is gelatinized and pasty is present at its surface;

3. In the inner part of the pasty layer except the central area, there are starch grains which are swollen by containing starch in a melted state;

4. The central area has a rearranged group of starch grains due to heat variation;

5. A three-layered structure comprising the formed layer which is gelatinized and pasty, the starch grains which are swollen by containing starch in a melted state and the rearranged group of starch grains due to heat variation is as shown in the picture under a scanning electron microscope of FIG. 1; and

6. When it is cooked by heating, nice smell of freshly cooked rice is strongly noted.

The first step of the present invention is that, in the state of uncooked rice, a gelatinized and pasty layer is formed at its surface only and that is also useful in the prevention of binding of cooked rice to form lumps when the water-absorbed rice is cooked by heating before eating. The pasty layer as such is also useful for the prevention of a quick absorption of water in the next heating treatment in the aqueous liquid and for the formation of rearranged starch grain group of starch grains due to heat variation in the central area of rice grain.

In the first step as such, for example, the material rice is placed in a basket, then placed in a container, pressure container (e.g., pressure cooker) or conveyer and heated at 100° C. to 200° C. for 2 seconds to 600 seconds or, preferably for example, steeped rice is heated for 120 seconds to 240 seconds, by using a heating means such as unpressurized steam, heated steam, pressurized steam and pressurized high-temperature water whereupon the pasty layer is formed at the surface of rice grain.

The material rice in which the pasty layer is formed is heated at 75° C. to 98° C. (temperature of the material) for 30 seconds to 20 minutes in the aqueous liquid by using a device, or a container such as a rice cooking kettle, a rice cooking device, a flat circular-shaped tray and a flat square-shaped tray.

The heating is carried out in such an extent that a degree of α-conversion of starch of rice grains becomes up to 85%, preferably 80% to 35% and, more preferably 75% to 50%.

For example, when a container such as a flat circular-shaped tray or a flat square-shaped tray is used, the material rice having the formed pasty layer is placed in the container, the aqueous liquid which is a slightly more than the aimed water content is placed thereto, the mixture is heated using a heating apparatus and, when a degree of α-conversion reaches 85% to 35% or, preferably 80% to 35&, more preferably 75% to 50%, the obtained α-converted rice is taken out from the heating apparatus—e.g., the α-converted rice is taken out together with the tray, or the α-converted rice is taken out from the tray and spread on a plate or a conveyer—and subjected to air-drying and/or drying under reduced pressure to give the water-absorbed rice containing less than 43% to 10% of water.

The air current for air-drying includes current of cool air, current of air of room temperature, current of warm air and current of hot air. The α-converted rice may be stirred in the air-drying and/or drying under reduced pressure in order to dry the α-converted rice efficiently.

The air-drying and/or the drying under reduced pressure may be carried out while the α-converted rice is being cooled, e.g., by using chilled water 3° C. to 7° C.

When a rice cooking kettle, a rice cooking device or the like is used, the material rice having the formed pasty layer is placed in a container made by a wire net, sunk in a rice cooking kettle or a rice cooking device in which the aqueous liquid is placed and heated, and when a degree of α-conversion reaches 85% to 35%, preferably 80% to 35% or, more preferably 75% to 50%, the resulting rice is taken out from the rice cooking kettle or rice cooking device together with the wire net container in which the resulting rice grains are placed, and the resulting rice grains are spread on a plate (e.g., plastic plate) or a conveyer (e.g., wire net conveyer) and air-dried by means of ventilation with a fan installed at the upper area of the plate or conveyer together with occasional stirring using a stirring blade. Alternatively, the air-drying is carried out in such a manner that ventilation is conducted by a fan installed at the upper and lower parts of the wire net conveyer, a horizontal bar is placed beneath the net of the moving wire net conveyer and, when rice grains go over the horizontal bar, the rice grains slip off whereby a stirring state is resulted. When the air-drying treatment as such is conducted under reduced pressure or in vacuo, it is possible to give the desired water content in a high efficiency in a short time.

In the present invention, the water content is adjusted to less than 43% to 10%, preferably 38% to 15% or, more preferably, 33% to 20% in the air-drying and/or dying under reduced pressure to manufacture the dried water-absorbed rice.

The state of the dried water-absorbed rice depends on the water content.

Thus, the dried water-absorbed rice where the water content is less than 43% to 20% is has a feeling of slightly soft and sticky. Although the dried water-absorbed rice where the water content is 20% to 10% shows a hard feeling, it is suitable for a long-term preservation. The water-absorbed rice of those water contents is preferred to be cooked after preservation by refrigerating or at ambient temperature and gives cooked rice having a nice smell of freshly cooked rice by heating with a microwave oven (500 watts for 3 to 20 minutes) after addition of an appropriate amount of water (e.g., heated water such as hot water and boiling water).

### ADVANTAGES OF THE INVENTION

In the present invention, the material rice is heated at high temperature for a short period so that gelatinized and pasty layer is formed at the surface of rice grains, the resulting material rice having the formed pasty layer is heated in the aqueous liquid at 75 to 98° C. (temperature of the material) for 30 seconds to 20 minutes and dried with air and/or dried under reduced pressure whereupon the dried water-absorbed rice of the present invention is able to be manufactured.

The dried water-absorbed rice of the present invention has a rearranged starch grain group of starch grains due to heat variation at the central area and, when it is cooked by heating, nice smell of freshly cooked rice is able to be strongly resulted.

### EXAMPLE 1

Polished rice (1.4 kg) of nonglutinous rice was washed and steeped in hot water of 40° C. for 30 minutes and the resulting steeped rice (1.8 kg) was placed in a rice basket, placed in a pressure cooker and heated at 120° C. at 2 atmospheric pressure: after temperature of rice reached 120° C., it was further heated for about 20 seconds at 120° C., and taken out from the pressure cooker to give material rice having a pasty layer on the surface of rice grains.

The resulting material rice (2.1 kg) having the formed pasty layer was placed in a flat circular-shaped tray of 8 cm height and 45 cm diameter and hot water (1.3 kg) of 90° C. was added thereto followed by transferring to a heating apparatus.

In the heating apparatus, heating was conducted at 85° C. for 10 minutes after temperature of the material reached 85° C. After completion of heating, the heated material rice (the degree of α-conversion: 50%) was taken out together with the tray from the heating apparatus and sunk in a water bath (water temperature: 5° C.), to which ice was added, to an extent of 3 cm from the bottom of the tray and, together with cooling as such, it was air-dried by ventilating with fans from both right and left sides.

During the air-drying, the material was stirred from time to time using a rake-shaped stirrer so that air-drying was accelerated.

When water content of the water-absorbed rice reached 39%, the air-drying was stopped to give 1.95 kg of dried water-absorbed rice.

The resulting dried water-absorbed rice is slightly soft upon pushing but its surface was still in a considerably dried state and was suitable for preservation at ambient temperature when a deoxidizer (AGELESS: trade name, Mitsubishi Gas Chemical Co., Ltd.) was added thereto.

The dried water-absorbed rice (112 g) preserved at ambient temperature for two weeks was placed in a container, boiling water (150 g) was added thereto and the mixture was heated for 7 minutes in a microwave oven (500 watts) whereupon cooked rice having good taste with a strong nice smell of freshly cooked rice was prepared.

1. A method for the manufacture of dried water-absorbed rice, which comprises heating a material rice at high temperature for a short period so that a gelatinized and pasty layer is formed at the surface of rice grains, and heating the resulting material rice having the formed pasty layer in an aqueous liquid at 75 to 98° C. (temperature of the material) for 30 seconds to 20 minutes, followed by air-drying and/or drying under reduced pressure to give the dried water-absorbed rice having the following physicochemical properties and water content of less than 43% to 10%;
Physicochemical properties:
(1) Starch grains specific to uncooked rice are not contained;
(2) A layer which is gelatinized and pasty is present at its surface;
(3) In the inner part of the pasty layer except the central area, there are starch grains which are swollen by containing starch in a melted state;
(4) The central area has a rearranged group of starch grains due to heat variation;
(5) A three-layered structure comprising the layer which is gelatinized and pasty, the starch grains which are swollen by containing starch in a melted state and the rearranged group of starch grains due to heat variation is as shown in the picture under a scanning electron microscope of FIG. 1; and
(6) When it is cooked by heating, nice smell of freshly cooked rice is strongly noted.

2. The method according to claim 1, wherein the material rice is heated at 100° C. to 200° C. for 2 seconds to 600 seconds by using a heating means selected from the group consisting of non-pressurized steam, heated steam, pressurized steam and pressurized high-temperature water to form the a pasty layer at the surface of rice grain.

3. The method according to claim 1, wherein the heating at 75° C. to 98° C. (temperature of the material) for 30 seconds to 20 minutes of the material rice having the formed pasty layer in the aqueous liquid is conducted by using a member selected from the group consisting of a rice cooking kettle, a rice cooking device, and a flat circular-shaped tray and a flat square-shaped tray.

4. The method according to claim 1, wherein the heating of the material rice having the formed pasty layer in the aqueous liquid is heating of such an extent that a degree of α-conversion of starch of rice grains becomes 85% to 35%.

5. The method according to claim 1, wherein the air-drying after the heating is conducted in such a manner that the material rice having the formed pasty layer is heated in the aqueous liquid, placed on a flat plate or a conveyer and air-dried with one member selected from the group consisting of current of cool air, current of air of room temperature, current of warm air and current of hot air so that the water content of the water-absorbed rice is made less than 43% to 10%.

6. The method according to claim 3, wherein, the air-drying and/or the drying under reduced pressure are/is conducted in such a manner that the material rice having the formed pasty layer is heated in the aqueous liquid by using the flat circular-shaped or flat square-shaped tray, taken out together with the tray and air-dried and/or dried under reduced pressure so that the content of the water-absorbed rice is adjusted to less than 43% to 10%.

7. The method according to claim 1, wherein stirring of the water-absorbed rice is conducted in the air-drying and/or the drying under reduced pressure so that the water content of the water-absorbed rice is adjusted to less than 43% to 10%.

8. The method according to claim 6, wherein, the air-drying and/or the drying under reduced pressure, are/is conducted in such a manner that a bottom of the flat circular-shaped or flat square-shaped tray in which the heated water-absorbed rice is placed is cooled with chilled water of 3° C. to 7° C.

9. The method according to claim 1, wherein the material rice is a member selected from the group consisting of nonglutinous rice and glutinous rice.

10. The method according to claim 9, wherein the material rice is a member selected from the group consisting of unpolished rice and polished rice.

11. The method according to claim 10, wherein the material rice is a member selected from the group consisting of non-washed rice, washed rice and steeped rice.

12. The method according to claim 1, wherein the aqueous liquid is a member selected from the group consisting of water and stock.

13. The method according to claim 1, wherein the aqueous liquid is heated.

14. The method according to claim 13, wherein the heated aqueous liquid is a member selected from the group consisting of warm water, hot water, boiling water, warm stock, hot stock and boiling stock.

15. The method according to claim 1, wherein the water content of the dried water-absorbed rice is 38% to 15%.

16. The method according to claim 15, wherein the water content of the dried water-absorbed rice is 33% to 20%.

17. The method according to claim 4, wherein the degree of α-conversion is 80% to 35%.

18. The method according to claim 17, wherein the degree of α-conversion is 75% to 50%.

19. The dried water-absorbed rice produced by the method according to claim 1.
